(19) United States
(12) Patent Application Publication
(10) Pub. No.: US 2008/0284566 A1
(43) Pub. Date: Nov. 20, 2008

(54) Location based electronic sign system

(76) Inventors: Li-Cheng Richard Zai, Los Gatos, CA (US); Xinyu Harry Zang, Sunnyvale, CA (US); Sophia Fang-Jung Liu, Cupertino, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 11/823,064

(22) Filed: Jun. 25, 2007

Related U.S. Application Data
(60) Provisional application No. 60/930,315, filed on May 15, 2007.

(51) Int. Cl. H04Q 1/00

(52) U.S. Cl. 340/7.56

(57) ABSTRACT

A method and an apparatus for determining the proximity between an electronic sign and one or more object items to transmit presentation information to the electronic sign are described. The determination may be based on a signal wirelessly generated from the electronic sign. The presentation information displayed at the electronic sign may describe the one or more object items. Locations of the one or more object items may be determined based on wirelessly received identifiers of the one or more objects items, a portable wireless device, and the electronic sign.

### CROSS-REFERENCE TO RELATED APPLICATIONS

This application is related to, and claims the benefits of, U.S. Provisional Patent Application No. US60/930,315, filed on May 15, 2007 entitled “Methods and Apparatus for Location-Based Electronic-Sign System”, which is incorporated by reference herein in its entirety.

### FIELD OF INVENTION

The present invention relates generally to data processing systems. More particularly, this invention relates to location based electronic sign systems.

### BACKGROUND

Electronic Shelf Labels (ESL) and Electronic Sign (ESign) systems have been deployed in recent years. A typical electronic-sign system comprises multiple electronic signs, multiple base stations, and a computer server. The electronic signs typically communicate with the computer server via base station wirelessly. The computer server may contain the identification numbers of the electronic signs, database for product codes and description of merchandise items, and commercial messages to be displayed by the electronic signs. A product code can be a Universal Product Code (UPC), an Electronic Product Code (EPC), or a vendor proprietary code. An electronic sign is normally assigned to a group of merchandise items, so that it can display the commercial messages, such as the price or promotion information, related to the specific items.

However, existing ESign systems only enable displaying promotional messages within a tightly controlled time window without providing locations of the electronic signs. The locations of these electronic signs are essential to the effectiveness for promoting merchandise items. For example, it is common for a merchant, who pays a store for promoting its items at certain locations within a certain time period, to monitor whether the merchandise items are correctly promoted. Furthermore, existing ESign systems may be prone to misplaced electronic signs which cause customer confusion and result in loss of potential revenues.

Therefore, existing ESign system are not reliable to satisfy the needs for both merchants and customers.

### SUMMARY OF THE DESCRIPTION

An embodiment of the present invention includes a method and apparatus that determine whether an electronic sign is placed within the proximity of one or more object items and transmit presentation information to the electronic sign. The determination may be based on a signal wirelessly received from the electronic sign. The presentation information may be displayed at the electronic sign describing the one or more object items. Locations of the one or more object items may be determined based on wireless signals generated by a portable wireless device and the electronic sign that are in the proximity of the one or more objects.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a network diagram illustrating one embodiment of a location based electronic sign system;

FIG. 2 illustrates an example of electronic signs located in association with a group of object items;

FIG. 3 illustrates examples of electronic signs which may be used with one embodiment of the invention;

FIG. 4 is a block diagram illustrating one embodiment of a system for an ESign (Electronic Sign) server that manages electronic signs;

FIGS. 5A, 5B and 5C illustrate examples of an ESign location map and an ESign information table;

FIG. 6 is a block diagram illustrating one embodiment of a base station in an ESign network;

FIG. 7 is a block diagram illustrating one embodiment of an electronic sign;

FIG. 8 illustrates an example of a data structure presenting message control information for an electronic sign;

FIG. 9 is a block diagram illustrating one embodiment of a system for a portable device in an ESign network;

FIG. 10 is a flow diagram illustrating one embodiment of a process to determine if an electronic sign matches an object item based on locations;

FIG. 11 is a flow diagram illustrating one embodiment of a process to match an electronic sign with an object item;

FIG. 12 is a flow diagram illustrating one embodiment of a process to update location based messages for an electronic sign;

FIG. 13 is a flow diagram illustrating one embodiment of a process to associate an electronic sign with an object item;

FIG. 14 is a flow diagram illustrating one embodiment of a process to display a location related message according to a machine-readable code wirelessly received;

FIG. 15 is a flow diagram illustrating one embodiment of a process to monitor locations of an electronic sign according to a placement plan;

FIG. 16 illustrates one example of a data processing system which may be used in an embodiment of an electronic sign of the present invention;

FIG. 17 illustrates one example of a data processing system which may be used in an embodiment of a base station of the present invention;

FIG. 18 illustrates one example of a data processing system which may be used in an embodiment of a portable device of the present invention;

FIG. 19 illustrates one example of a typical computer system which may be used in an ESign server in conjunction with the embodiments described herein.

### DETAILED DESCRIPTION

A method and an apparatus for electronic sign systems based on locations are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In one embodiment, an electronic sign may display electronic messages for an information display relevant to spatially associated movable object items based on physical locations. A movable object item may be, for example, a merchandise item associated with one or more product groups, or a graphics advertisement print for a particular product group. Note that throughout this application a merchandise item is used as an example of an object item. However, it is not so limited; other types of objects may also be applied

In one embodiment, an electronic sign may be a wireless device including an information display. An object item may be located based on a wireless device, such as an RFID (Radio Frequency Identification) device, which may be an active or passive type and is attached to or associated with the object item. In another embodiment, an object item may be located via a portable wireless device placed in a close vicinity of the object item. Locations of a wireless device may be detected based on physical measurement of wireless signals generated by the wireless device and received by three or more wireless base stations. A proper message for an electronic sign to display may be automatically determined based on a real-time tracking of where the electronic sign (information display) is located and which object items are within similar vicinity. Remote monitoring and control of electronic signs may be significantly enhanced with automatically acquired location data to identify associated product information.

According to one embodiment, electronic signs display electronic messages according to a schedule and/or a location map. Operation status of an electronic sign including, for example, time, duration, locations and messages may be tracked and monitored automatically according to a predetermined plan. Deviation of an electronic sign from a schedule or location plan may be detected in real time to generate notification messages for correcting actions. In one embodiment, operating histories including location traces (paths) of an electronic sign may be automatically logged to verify, for example, an advertisement message having been displayed in a certain area according to a schedule.

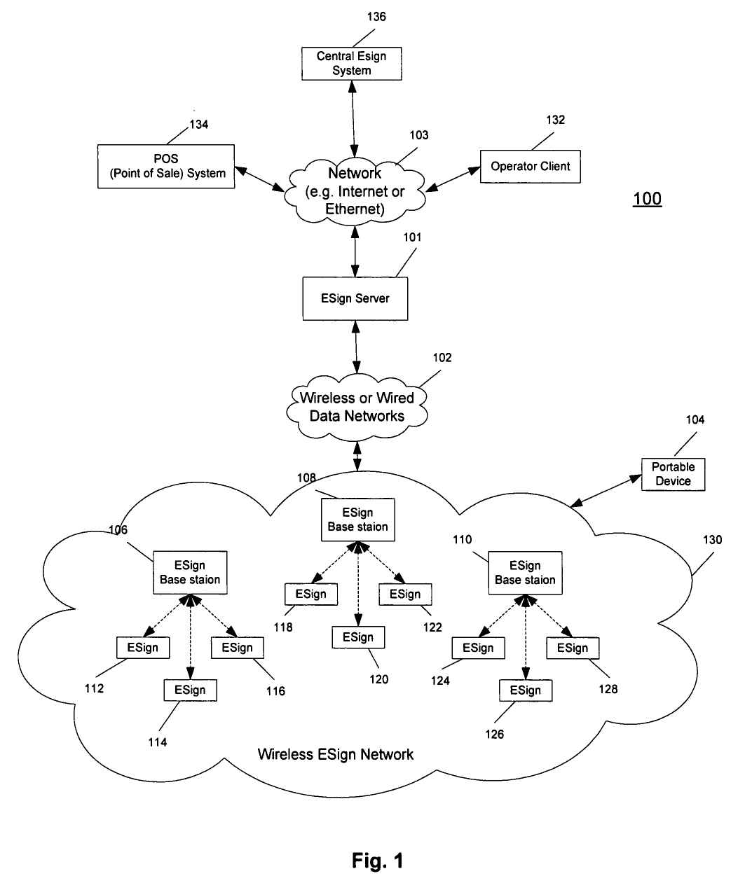

FIG. 1 is a network diagram illustrating one embodiment of a location based electronic sign system. In one embodiment, network system 100 may provide an ESign system including multiple electronic signs, for example, ESign 112, ESign 114 to ESign 128. An electronic sign may be a movable information display coupled with a wireless device, e.g. RFID tag. One or more electronic signs, such as ESign 112 to ESign 128 may be associated with a base station or repeater, such as ESign base station 106, over a wireless ESign network, such as ESign network 130. An electronic sign may include a wireless transceiver that is capable of wirelessly communicating with another wireless endpoint such as a base station (e.g., an access point) or server. For example, an electronic sign may be an RF (Radio Frequency) or an IR (Infrared) compatible device. An electronic sign, such as ESign 112, may perform wireless network transactions with its associated base station, such as ESign base station 106. A base station may be placed at a relatively fixed location to serve as a hub and/or a gateway between a data network, e.g. data network 102, and electronic signs ESign 112 to Esign 128. In one embodiment, a base station, such as ESign base station 106, may receive and monitor wireless data packets from a wireless device not currently associated, such as ESign 128 associated with ESign base station 110 but not with ESign base station 106. More than one base station may be placed at multiple locations to provide a coverage over an area, such as a store space. Portable wireless device 104 may join or leave wireless ESign network 130 dynamically. In one embodiment, portable device 104 may selectively perform network transactions over a wireless medium directly with either an electronic sign, a base station in ESign network 130, or a server (e.g. server 101).

An electronic sign, such as ESign 112, of ESign network 130 may be coupled with a store ESign server 101 over a data network 102 via a base station, such as ESign base station 106. Data network 102 may be wireless or wired network. Data network 102 may further include multiple networks or sub-networks. ESign server 101 may be located locally or remotely with respect to electronic signs ESign 112 to ESign 128 of ESign network 130. A store ESign server 101 may receive, periodically or on demand, physical measurements of wireless signals for a wireless device, such as an electronic sign 112 or a portable wireless device 104, monitored from a plurality of base stations belonging to the same wireless network as with the wireless device. In one embodiment, an ESign store server, such as server 101, may provide location tracking capability for wireless devices, such as electronic signs and portable devices, in a wireless network. Additionally, an ESign store server 101 may identify association relationships among objects items, such as an information display, a merchant item, or a printed information item, based on wirelessly tracked locations. Decisions may be made at an ESign store server 101 to manage electronic messages to be displayed by an electronic sign 106.

In one embodiment, an ESign server, such as server 101, may be coupled with store systems including a POS (Point of Sale) system 134 and/or a central ESign system 136 over a network 103, such as Ethernet or Internet, to receive business related information in association with a wirelessly located object item, such as an electronic sign 106 or a merchant item placed in a vicinity or proximity of an electronic sign 106. The displayed information may include pricing update, and/or promotional messages to be displayed in an electronic sign 106. A client system, such as operator client 132, may be coupled with a central ESign system 136 over a network 103, such as an Ethernet network or Internet, to allow an operator to remotely monitor misplaced object items according to wirelessly tracked locations from the ESign server 101.

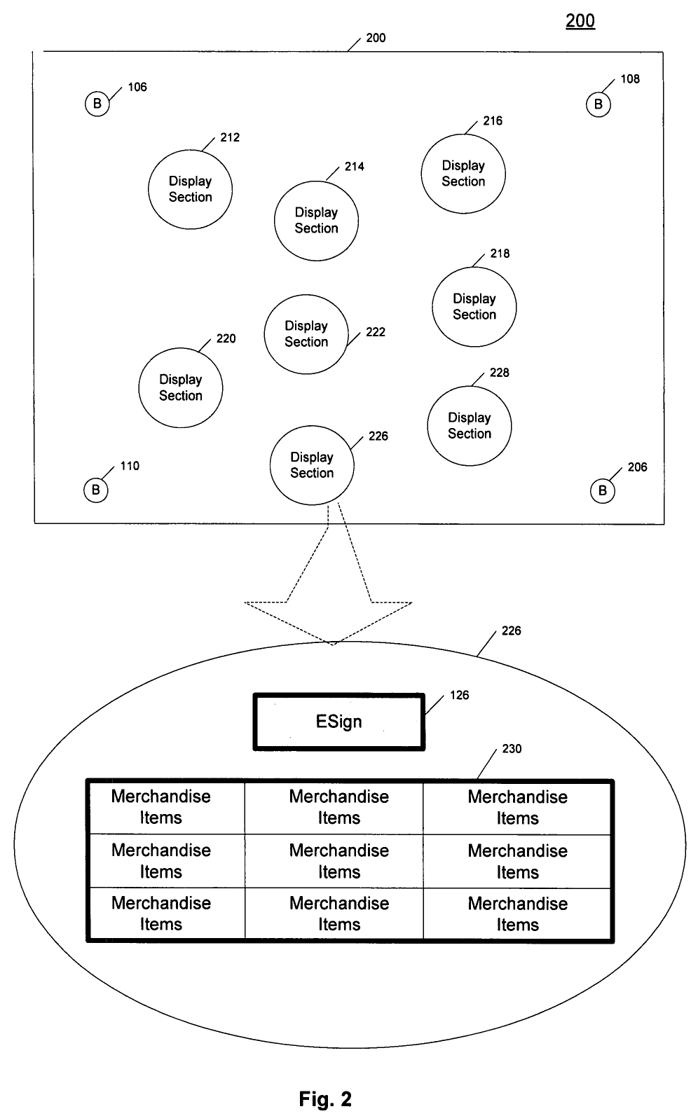

FIG. 2 illustrates an example of electronic signs located in association with a group of object items. In one embodiment, area 200 may be covered by ESign network 130 of FIG. 1. Base stations 106, 108, 110 and 206 may be placed around multiple points (e.g. four corners) of area 200. A display section in area 200 may be associated with one base station over ESign network 130 via an electronic sign placed within the display section. For example, electronic sign ESign 126 may be placed within display section 226 wirelessly associated with base station 110. Electronic sign ESign 126 may be located closest to base station 110 compared with other base stations 106, 108 and 206. Area 200 may include multiple of non-overlapping display sections, such as display section 212 to display section 228. An electronic sign, e.g. ESign 126 in a display section, e.g. display section 226, may display messages relevant to merchant items, e.g. merchant items 230, located within the display section 226. Each merchant item within one display section may belong to one product group, such as based on product brands or product categories. In one embodiment, the distance between a merchant item and an electronic sign of the same display section may be the shortest compared with distances between the merchant item and electronic signs of other display sections.

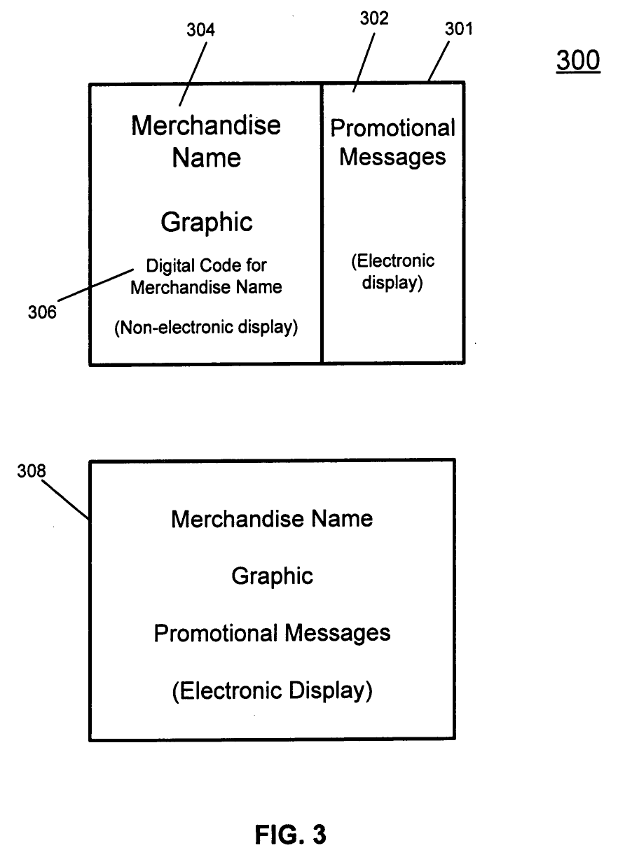

FIG. 3 illustrates examples of electronic signs which may be used with one embodiment of the invention. In one embodiment, electronic sign 301 with an electronic display 302 may be placed together with a non-electronic display 304, such as a physically printed section. Electronic sign 301 may display any information or messages such as promotional messages for a merchandise item illustrated on non-electronic display 304 including merchandise names and related graphics information. In one embodiment, a non-electronic display 304 may include a digital code 306 (also referred to as a machine-readable code) to associate with a merchandise item related to the displayed information. A digital code 306 or machine-readable code may be imprinted on a surface of a non-electronic display (e.g. a barcode, or other OCR or optical character recognition codes). A remote device, such as an optical reader or scanner may access a digital code wirelessly from a close distance. In one embodiment, a digital code may be a bar code. An electronic sign, such as electronic sign 308 may include an electronic display capable of displaying message data and graphics information. Supplementing data messages from an electronic display, such as electronic sign 301, with rich graphics information using a non-electronic display, such as non-electronic display 302, may be more cost effective compared with using a more capable electronic sign, such as electronic sign 308, to display both messages and graphics.

According to one embodiment, a portable device 104 (e.g, scanner) may obtain the machine-readable code 306 by scanning the non-electronic section of an electronic sign 304. The portable device 104 may wirelessly transmits the machine-readable code into the electronic section 302 of the electronic sign 301. The electronic sign 301 in turn may wirelessly transmit (via a base station) the machine-readable code as well as its identifier to an ESign server 101 to allow the system to associate (e.g., pair up) the electronic sign with one or more object items that are identified by the machine-readable code. In addition, the ESign server101 can determine whether a particular electronic sign is located within a proximity of an object item identified by the machine-readable code, where the location of the object item may have been previously obtained, for example, by a portable device while scanning (e.g., a machine-readable such as UPC code) the object item. Further, based on the machine-readable code306 of an object item and the identifier of an electronic sign, the ESign server 101 can determine a proper message to be displayed in an electronic section 302 of the electronic sign 301. As a result, the ESign_server101 may transmit the proper message to the electronic sign 301 to be displayed by the electronic section 302 for matching the items identified or described by the non-electronic section 304.

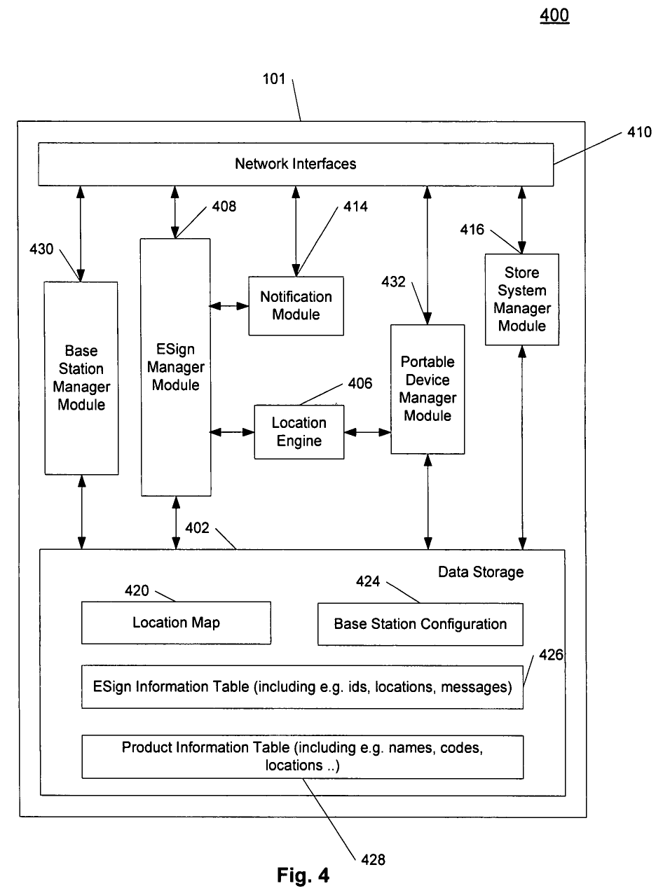

FIG. 4 is a block diagram illustrating one embodiment of system for an ESign server that manages electronic signs. In one embodiment, system 400 may be implemented as part of ESign server 101 of FIG. 1. Network interfaces 410 of system 400 may provide interfaces for both wired, such as Ethernet, and/or wireless, such as RF or IR networks. Base station manager module 430 may monitor and configure base stations 106, 108, and 110 coupled with ESign server 101 via network interface 410. In one embodiment, base station manager module 430 may configure a wake up period to a ESgin 112 via base station 106 for determining how often an ESign 112 associated with the base station 106 should send out a self initiated data packet. Store system manager module 416 may interface to a central ESign system, such as central ESign system 136 of FIG. 1, a POS system, such as POS system 134 of FIG. 1, and/or a client system for a store system operator, such as operator client 132 of FIG. 1. Store system manager module 410 may receive updates on data and/or control information for associated ESign devices, such as messages, display schedules and/or display locations from a central ESign system 136. In one embodiment, store system manager module 410 may receive product pricing data from a POS system 134 for verifying consistency with a message displayed by an associated ESign device 112. A client (e.g. an operator) may request a status report from ESign server 101 via store system manager module 410 based on data stored in data storage 428.

In one embodiment, data storage 402 may be a data base or a data storage structure to store messages, schedules, locations, product information and/or device configuration parameters, such as ESign device wake up periods. Data storage 402 may include a location map, such as location map 420. In one embodiment, a location map may include geometric or geographic data over a store area where associated ESign devices, such as ESign 112 to ESign 128 of FIG. 1, and base stations, such as ESign base stations 106, 108 and 110, are located. Additionally, location map 420 may provide geometric data on space partitions, such as non-overlapping zones, over a store area. In one embodiment, control information about an ESign device location may be specified based on one or more zones of a store area. An ESign information table 426 may include information for an ESign device, such as an identification, a location data, display messages, and a display schedule.

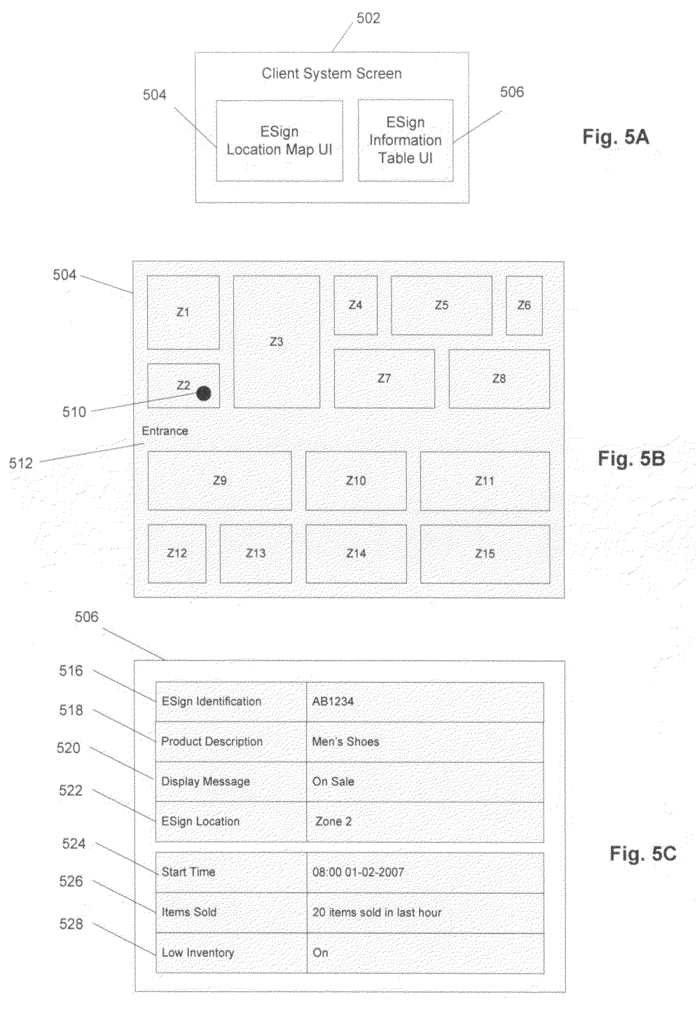

FIGS. 5A, 5B and 5C illustrate examples of an ESign location map and an ESign information table. In one embodiment, user interface example of FIG. 5A may be based on a client system screen 502 of an operator client, such as operator client 132 of FIG. 1, for a store operator. Client system screen 502 may include a user interface 504 for accessing an ESign location map, such as location map 420, and a user interface 506 for accessing an ESign information table, such as ESign information table 426 of FIG. 4, retrieved from an ESign server, such as ESign server 101 of FIG. 1. User interface 504 of FIG. 5B may be based on geometric data from location map 420 of FIG. 4 for a store area including a one or more zones, such as entrance zone 512. ESign information table user interface 506 may include data from a ESign information table corresponding to an ESign device located at position 510 of zone Z2 of FIG. 5B. In one embodiment, the ESign information table associated with user interface 506 may include an ESign identification 516, display messages 520, a location identifier as zone 522 and start time for message display schedule 524. Description 518 may be associated with products matched with an ESign based on location matching. ESign information table user interface 506 may include data related to products associated with an ESign device 112, such as real time transaction (e.g. sale) information 526 and inventory level indicator 528. In one embodiment, product related data may be retrieved by an operator client system 132 from a central ESign server, such as central ESign system 136 of FIG. 1 or collected over POS systems, such as POS system 134 of FIG. 1.

Referring back to FIG. 5, in one embodiment, data storage 402 may include base station configuration 424 for configuration data such as ESign device wake up periods and/or location data for base stations. In one embodiment, data storage 402 may include product information table 428 which may store product related information such as product identifiers (e.g. names), product codes (e.g. bar codes), product locations etc. Product information data 428 may be updated by a central ESign server, such as central ESign system 136 of FIG. 1, via store system manager module 410. In one embodiment, product locations may be provided based on a location of a portable device, such as portable device 104 of FIG. 1, forwarding a product code via a portable device manager module, such as module 432. Portable device manager module 432 may send requests to multiple base stations for location related data of a portable device identified by a portable device identifier in association with a product code received. Alternatively, a portable device may directly communicate wirelessly with an ESign server 101 regarding its location. Location engine 406 may determine a current location of a portable device based on separate location related data for the portable device from multiple base stations. In one embodiment, location engine 406 may determine a location based on fixed locations of base stations stored in configuration 424 for a base station. Portable device manager module 432 may update product information table 428 according to a product code and associated location determined by location engine 406.

ESign manager module 408, according to one embodiment, may receive a product code from an ESign device identified by an ESign identifier. In one embodiment, ESign manger module 408 may determine if a product code matches an ESign identifier according to product information table 428 and ESign information table 426. Matching a product code and an ESign identifier may be based on matching associated location information. In one embodiment, two locations may match each other if both belong to a same zone of a location map, such as location map 420. If a mismatch is detected, ESign manager module 408 may send a notification message via notification module 414 to an operator client system. In another embodiment, ESign manager module 408 may periodically request current location related data of an ESign device from a plurality of base stations. A current location for an ESign device may be determined at location engine 406 according to current location related data received. ESign manager module 408 may update ESign information table 426 with current locations of ESign devices determined by location engine 406.

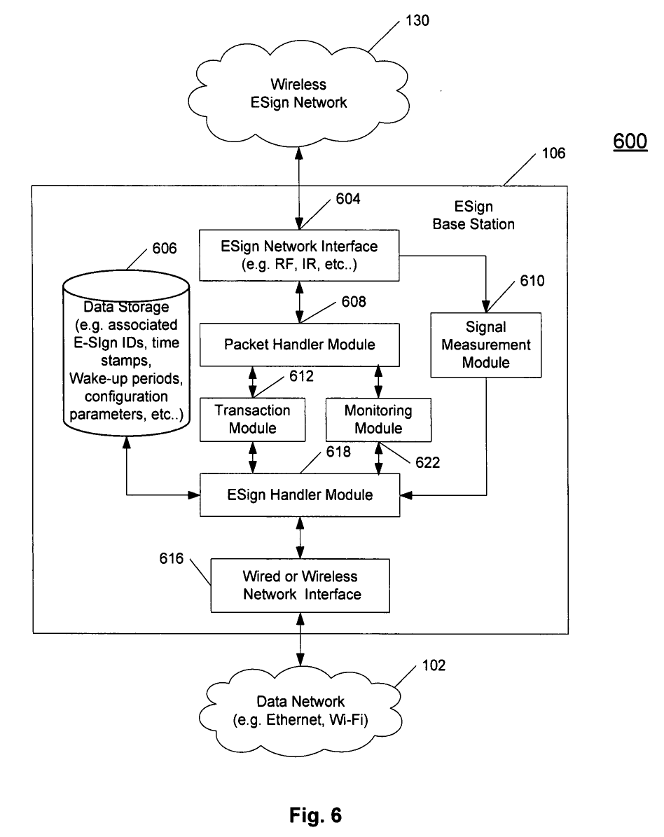

FIG. 6 is a block diagram illustrating one embodiment of a base station in an ESign network. In one embodiment, base station 106 may be communicatively coupled with a wireless network such as wireless ESign network 130 of FIG. 1. Base station 106 may communicate with an ESign server, such as ESign server 101 of FIG. 1 over a data network 102. Base station 106 may include ESign network interface 604 for interfacing with a wireless network, such as an RF network or IR network. Base station 106 may also include a data network interface module 616 to interface with a wired or wireless data network, such as an Ethernet or Wi-Fi (Wireless Fidelity) network. In one embodiment, base station 106 may include signal measurement module 610 to determine signal strength, e.g. physical strength of wireless signals, associated with wireless data packet received via ESign network interface 604. Signal measurement module 610 may be based on a TOA (Time Of Arrival) indicator or an RSS (Received Signal Strength) indicator of wireless signals associated with received data packets.

According to one embodiment, ESign base station 106 may include a packet handler module, such as module 608, coupled with ESign network interface 604 for packing and/or unpacking wireless data according to a predetermined protocol. Packet handler module 608 may forward transaction module 612 with wireless data packets destined to base station 106, such as data packets from associated ESign devices 112, 114, and 116 in ESign network 130. Transaction module 612 may activate ESign handler module 618 to perform a data transaction with another wireless device, such as ESign device 112, ESign base station 108 or a portable wireless device 104. ESign handler module 618 may perform read/write operations on data storage 606 for data transactions. In one embodiment, ESign handler module 618 may determine location based network associations with other wireless devices within ESign network 130, such as ESign device 112 or portable device 104. ESign handler module 618 may establish a location based network association with another wireless device based on wireless signal strength indicators from signal measurement module 610.

In one embodiment, ESign network interface 604 may receive wireless data packets from a wireless device within ESign network 130 regardless whether the wireless device is associated with base station 106. For example, ESign network interface 604 may receive wireless data packets from ESign device 128 which is not associated with base station 106 within ESign network 130. Packet handler module 608 may forward monitoring module 622 with a received wireless data packet not destined to base station 106. Monitoring module 622 may activate ESign handler module 618, according to a predetermined schedule, to store a signal strength and a source identifier, e.g. ESign device identifier, associated with a received data packet to data storage 606. In one embodiment, data storage 606 may be a data storage structure to store ESign identifiers, location related data, for example signal strength indicators, with time stamps, wake-up periods for tracking network associations and/or other configuration parameters.

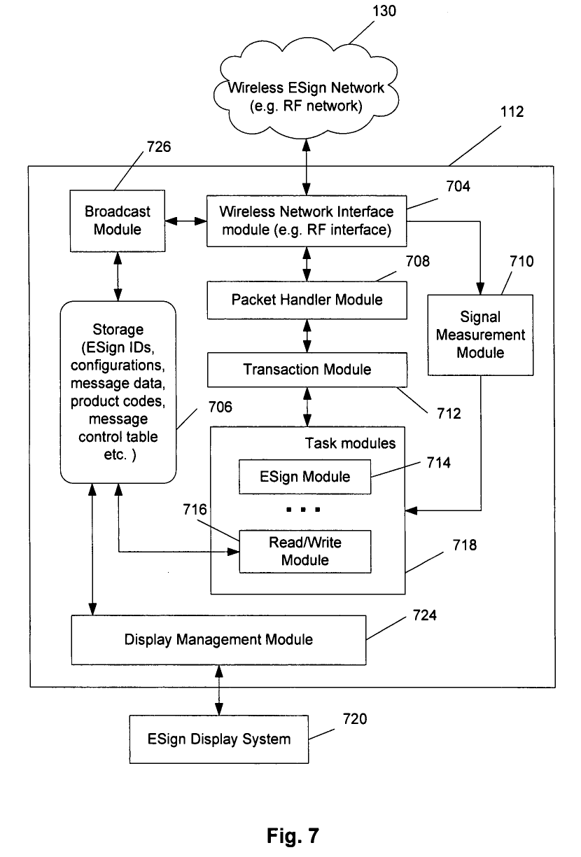

FIG. 7 is a block diagram illustrating one embodiment of an electronic sign, such as ESign device 112 of FIG. 1. In one embodiment, ESign 112 may be associated with base station 106 in ESign network 130 of FIG. 1. ESign 112 may interface with ESign network 130 via wireless network interface module 704. In one embodiment, ESign device 112 may include signal measurement module 710 to determine a signal strength associated with wireless data packet received via wireless network interface module 704. Signal measurement module 710 may perform the measurement based on a TOA (Time Of Arrival) indicator or an RSS (Received Signal Strength) indicator of wireless signals associated with received data packets. A packet handler module, such as module 708, may be coupled with wireless network interface module 704 for packing and/or unpacking wireless data according to a predetermined protocol. A communication module such as broadcast module 726 may broadcast data packets, according to a schedule, to ESign network 130 via wireless network interface module 704. Data packets broadcasted may include a self identifier uniquely identifying a source ESign device, such as device 112, within ESign network 130.

In one embodiment, transaction module 712 may perform data transactions with wireless devices in ESign network 130, such as ESign base station 106 to ESign base station 110, or portable device 104 of FIG. 1, via packet handler module 708. Periodically, transaction module 712 may send out polling requests to selected base stations, such as base station 106 of FIG. 1, for maintaining network associations within ESign network 130. In response to received wireless data packets, transaction module 712 may activate one or more task modules. For example, a packet received from base station 106 of FIG. 1 may include a command requesting a particular data collected by ESign device 112. Accordingly, transaction module 712 may activate read/write module 716 to retrieve the requested data from storage 706 for transaction module 712 to send back to base station 106 of FIG. 1 via packet handler module 708. In one embodiment, task modules 718 may include a plurality of modules to perform data transaction tasks for transaction module 712. Task modules 718 may include ESign module 714 to manage association, authentication, and communication with a base station, such as base station 106 of FIG. 1.

Storage 706 may be a data base or a data storage structure for storing data including identifiers or digital codes associated with ESign devices, print displays and/or merchandise objects. Data stored in storage 706 may also include display messages for ESign device 112, configuration parameters, such as timing periods for ESign device 112 to stay inactive for preserving power usage and/or a broadcast schedule of broadcast module 726. Additionally, in one embodiment, storage 706 may store message control tables for message selection and scheduling. Display management module 724 may drive ESign display system 720 coupled with ESign 112 to display ESign messages according to message control tables and messages stored in storage 706. In one embodiment, ESign display system 720 may include electronic displays, such as, for example, LCD (Liquid Crystal Display) or EPD (Electronic Paper Display) based display panels.

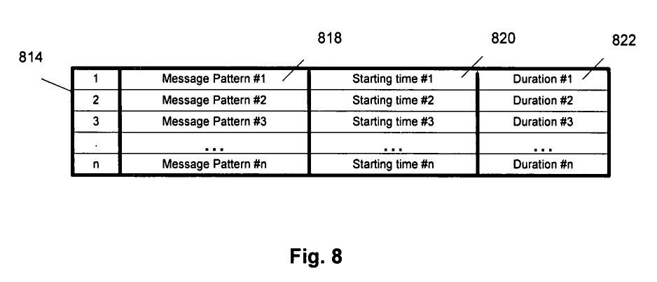

FIG. 8 illustrates an example of a data structure presenting message control information for an electronic sign, such as ESign device 112 of FIG. 1. Control information 814 may be a message control table stored in a storage of an ESign device, such as storage 706 of FIG. 7. In one embodiment, control information 814 may include multiple message entries to be displayed by an ESign device. A message entry in control information 814 may include, for example, display messages, starting time for displaying messages and a display duration, such as message pattern 818 with starting time 820 for duration 822. An ESign device may display different messages at different times according to associated message control information.

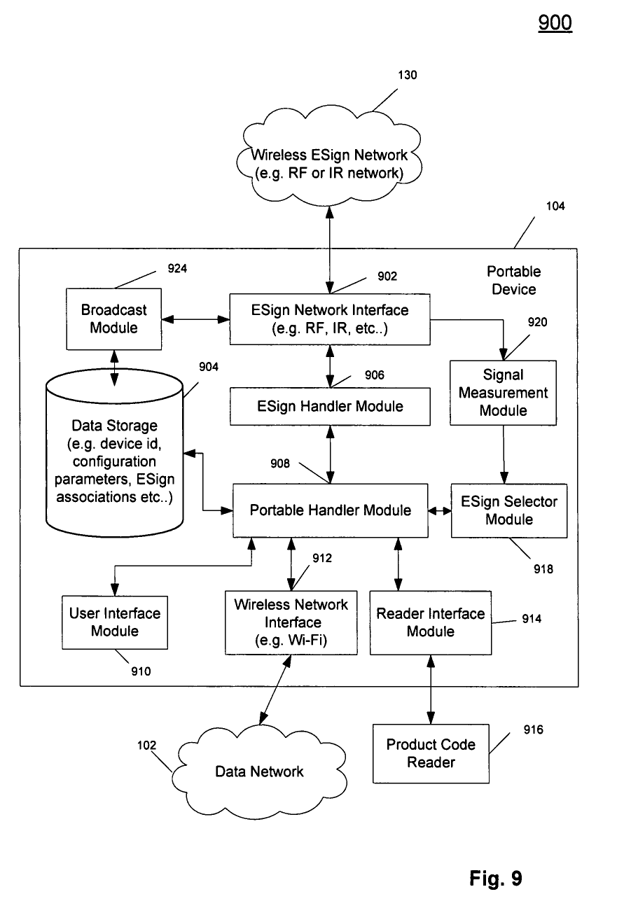

FIG. 9 is a block diagram illustrating one embodiment of a system for a portable device, e.g. portable device 104 in an ESign network, such as ESign network 130 of FIG. 1. In one embodiment, portable device 104 may interface with ESign network 130 via ESign network interface 902. Portable device 104 may include signal measurement module 920 to determine a signal strength associated with wireless data packet received via ESign network interface 902. Signal measurement module 920 may perform measurements based on a TOA indicator or an RSS indicator of wireless signals associated with received data packets. ESign handler module 906 may perform reading data from and/or writing data into an ESign device dynamically associated with portable device 104 in ESign network 130. Broadcast module 924 may broadcast data packets over ESign network 130 via ESign network interface 902 according to a schedule as configured in data storage 904. Data packets broadcasted may include a self identifier uniquely identifying portable device 104 within ESign network 130.

In one embodiment, portable device 104 may interface with product code reader 916 via reader interface module 914. Product code reader 916 may remotely retrieve digital or machine-readable codes, e.g. a bar code, imprinted on a surface of an object. In one embodiment, product code reader 916 may be a bar code reader or an optical (e.g. OCR) scanner. Portable handler module 908 may send digital codes received from reader interface module 914 to a selected ESign device via ESign handler module 906. In one embodiment, ESign selector module 918 may select an ESign device associated with portable device 104 for portable handler module 908 according to wireless signal strength measured according to signal measurement module 920. In one embodiment, portable handler module 908 may activate product code reader to retrieve product codes from merchant items according to user commands received from user interface module 910. Portable handler module may send a digital code to a selected ESign device or to a predetermined network destination, such as, for example, ESign server 101 of FIG. 1. In one embodiment, portable device may interface with data network 102 via wireless network interface 914. Data network 102 may be a Wi-Fi based wireless network. Portable device 104 may communicate with an ESign server 101via data network 102. Storage 904 may be a data base or a data structure for storing data including device identifiers, dynamic associations with ESign devices and configuration parameters, such as, for example, broadcasting schedule for broadcast module 924.

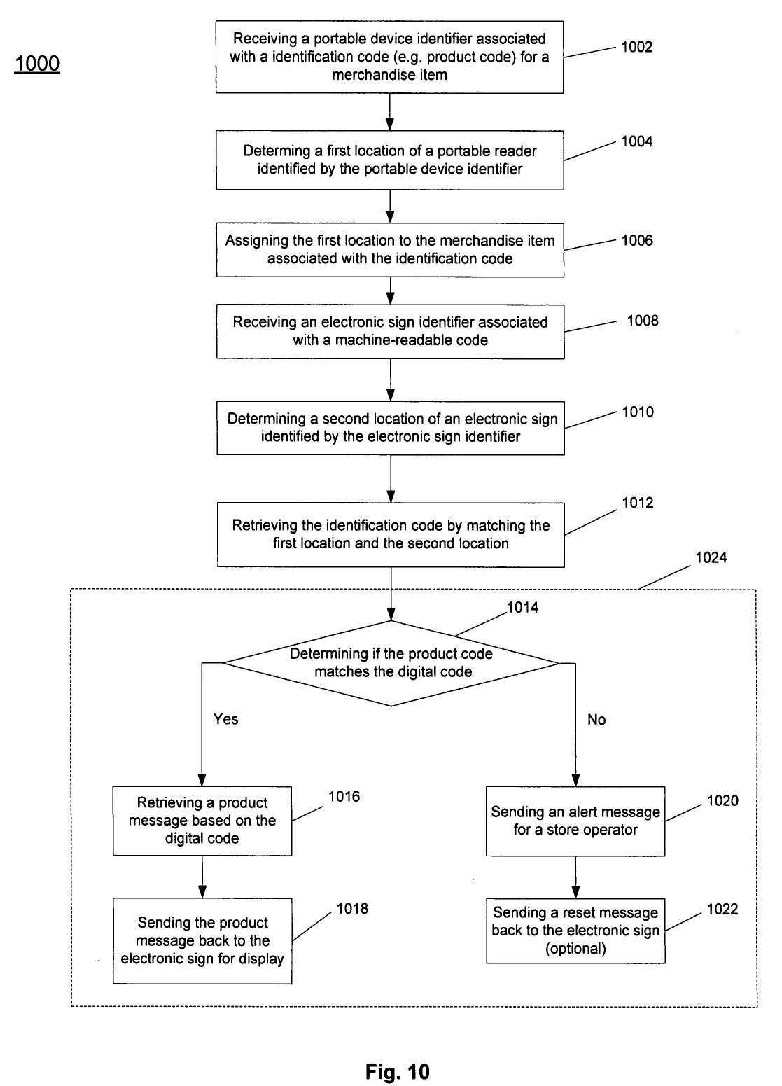

FIG. 10 is a flow diagram illustrating one embodiment of a process to determine if an electronic sign matches an object item based on locations. Process 1000 may be performed by processing logic (e.g. software and/or hardware) that may be implemented as part of system 400 of FIG. 4. In one embodiment, processing logic may receive a portable device identifier associated with an identification code, such as a product code, for a merchandise item at block 1002. Processing logic may receive data packets including the portable device identifier and the identification code from a data network such as network 102 of FIG. 1. A portable device 104 may be uniquely identified by a portable device identifier 104 within an ESign network, such as ESign network 130 of FIG. 1. In one embodiment, the portable device 104 may be placed in a close vicinity of the merchandise item associated with the identification code.

At block 1004, processing logic may determine a first location of the portable device identified by the portable device identifier. In one embodiment, processing logic may retrieve current location related data for a portable device from a plurality of base stations fixed at different locations, such as base station 106 to base station 108 of FIG. 1, to locate the portable device. A location related data may be based on wireless signal strength indicators, such as RSS indicators or TOA indicators for wireless data packets received at multiple base stations. In another embodiment, processing logic may retrieve current location related data for a portable device from a storage, such as data storage 402 of FIG. 4. A plurality of base stations may periodically send collected location related data for a portable device to the ESign server 101. In one embodiment, processing logic may locate a portable device based on fixed locations of base stations and associated signal strength indicators, such as performed by location engine 406 of FIG. 4. At block 1006, processing logic may assign a first location located for the portable device at block 1002 to the merchandise item according to an associated product code.

At block 1008, in one embodiment, processing logic may receive an electronic sign identifier associated with a machine-readable code. Processing logic may receive data packets including both an electronic sign identifier and a machine-readable code. An electronic sign identifier may uniquely identify an electronic sign within an ESign network, such as ESign device 112 of ESign network 130 of FIG. 1. A machine-readable code may be associated with a display object. In one embodiment, a machine-readable code may be imprinted on a surface of a display object, such as a bar code, UPC (Universal Product Code) code or EPC (Electronic Product Code) code. At block 1010, processing logic may determine a second location of an electronic sign identified by the electronic sign identifier. In one embodiment, processing logic may locate an electronic sign at block 1010 in a similar way to locate a portable device at block 1004. At block 1012, processing logic may retrieve the identification code by matching the second location for the electronic sign against the first location associated with the identification code. In one embodiment, processing logic may perform location matching between the second location and a plurality of locations associated with a plurality of identification codes stored in a storage, such as data storage 402 of FIG. 4. Location matching may be based on a predetermined threshold distance between different locations. In one embodiment, location matching may include finding a minimum distance.

At block 1014, processing logic may determine if the retrieved identification code at block 1012 matches the received digital code at block 1008. In one embodiment, processing logic may identify product groups associated with identification codes and machine-readable codes from pre-stored product information, such as product information table 428 of FIG. 4. A machine-readable code and an identification code may match if both belong to a common product group. If a match is found, in one embodiment, processing logic may retrieve a product message associated with the matched digital code. Product messages may be stored associated with digital codes in a storage, such as ESign information table 426 of FIG. 4. At block 1018, processing logic may send the product message retrieved at block 1016 back to the electronic sign for display. If no match is found at block 1014, processing logic may send an alert message for a store operator. Processing logic may send an alert message to a client system coupled through a data network, such as operator client 132 in network 103 of FIG. 1. Optionally, processing logic may send a reset message to the electronic sign to reset display messages, such as to blank out electronic display panel associated with the electronic sign.

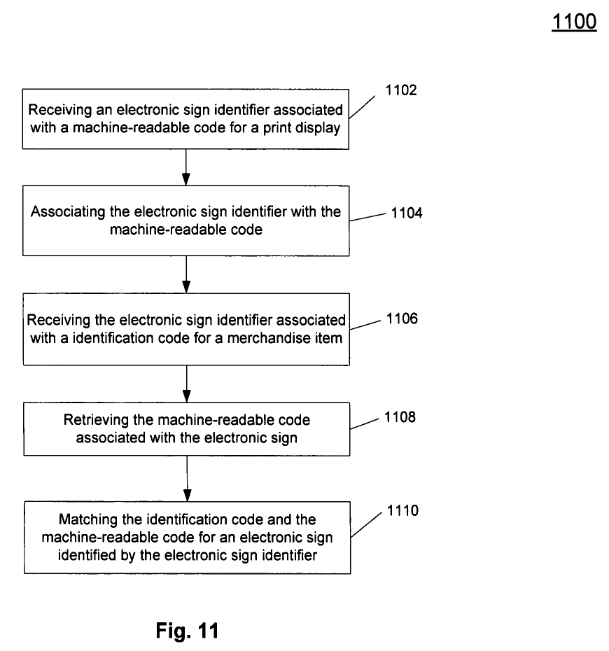

FIG. 11 is a flow diagram illustrating one embodiment of a process to match an electronic sign with an object item. Process 1100 may be performed by system 400 of FIG. 4. In one embodiment, process 1100 may receive an electronic sign identifier associated with a machine-readable code from network data packets at block 1102. The wireless data packets may be received from an electronic sign, such as ESign 112 of FIG. 1, identified by the electronic sign identifier. The machine-readable code may be a UPC code, an EPC code or a bar code imprinted on a surface of a print display associated with the electronic sign. At block 1104, process 1100 may associate an electronic sign identifier with a machine-readable code in a storage, such as data storage 402 of FIG. 4. In one embodiment, process 1100 may receive an electronic sign identifier associated with an identification code at block 1106. The identification code may be associated with one or more merchandise items, such as a bar code or a product name imprinted on a surface of the merchandise item. In one embodiment, the electronic sign identifier may be received via wireless data packets from an electronic sign identified by the identifier. At block 1108, process 1100 may retrieve the machine-readable code associated with the electronic sign identifier, for example, from a storage. In one embodiment, process 1100 may proceed to match the identification code with the machine-readable code at block 1024 as in FIG. 10.

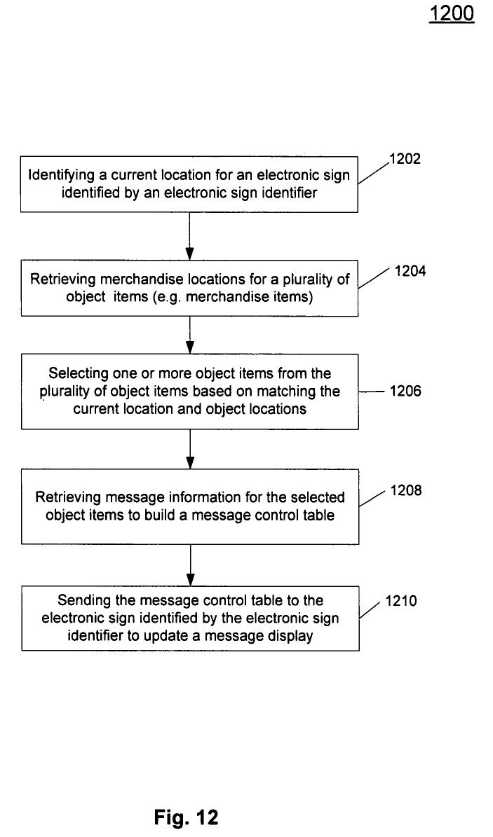

FIG. 12 is a flow diagram illustrating one embodiment of a process to update location based messages for an electronic sign. Process 1200 may be performed by processing logic (e.g. hardware and/or software) implemented as part of system 400 of FIG. 4. At block 1202, processing logic may identify a current location of an electronic sign, such as ESign 112 of FIG. 1. An electronic sign identifier may be received to identify an electronic sign. In one embodiment, a data packet sent from an electronic sign may include an identifier identifying the electronic sign. Processing logic may locate the electronic sign at block 1202 similar to process 1000 at block 1010. At block 1204, processing logic may retrieve merchandise locations for a plurality of object items, such as merchandise items. In one embodiment, merchandise locations may be stored according to product codes associated with corresponding object items according to, for example, process 1000 at block 1006.

Processing logic may match the current location of an electronic sign and retrieved object locations to select one or more object items from the plurality of object items. In one embodiment, the selected object items based on location matching may have locations close to the current location of the electronic sign. Processing logic may perform the location matching at block 1206 similar to process 1000 at block 1012. In one embodiment, at block 1208, processing logic may retrieve message information related to the selected object items from pre-stored product information, such as product information table 428 of FIG. 4. An object item may be associated with one or more product codes stored in a product information table with corresponding product messages. Processing logic may build a message control table, such as table 814 of FIG. 8, based on the retrieved product information. At block 1210, processing logic may send the message control table to the electronic sign identified by the electronic sign identifier to display product messages in an associated electronic display.

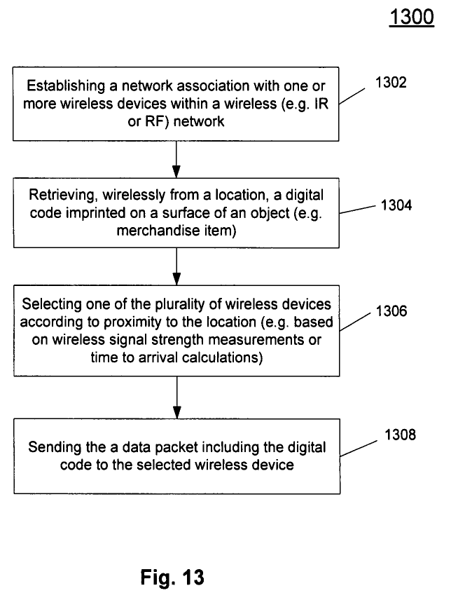

FIG. 13 is a flow diagram illustrating one embodiment of a process to associate an electronic sign with an object item. Process 1300 may be performed by processing logic (e.g. software and/or hardware) implemented as part of portable device 104 of FIG. 9. In one embodiment, processing logic may dynamically establish network associations with one or more wireless devices within a wireless network, such as ESign device 112 to 118 within ESign network 130 of FIG. 1. Dynamic wireless network associations may be based on physical proximities between wireless devices. At block 1304, processing logic may retrieve a digital code imprinted on a surface of an object, such as a merchandise item. In one embodiment, processing logic may optically retrieve a digital code by a code reader, such as product code reader 916 of FIG. 9, in response to a user command. At block 1306, process 1306 may select one of a plurality of wireless devices, such as ESign device 112 to ESign device 118 of FIG. 1. The selection at block 1306 may be based on location proximities with wireless devices. Processing logic may select a wireless device closest to a location from among a plurality of wireless devices having network associations. In one embodiment, location proximities may be determined based on wireless signal strength measurements, such as RSS indicators or TOA indicators from signal measurement module 920 of FIG. 9. In another embodiment, location proximities may be calculated by a location engine, such as location engine 406 of FIG. 4, at a server, such as ESign server 101 of FIG. 1. In one embodiment, processing logic may perform selection at block 1306 substantially from the same location and substantially at the same time as in block 1304. At block 1308, processing logic may send a data packet including the digital code retrieved at block 1304 to the selected wireless device. In one embodiment, processing logic may send the digital code via the dynamically associated network, such as ESign network 130 of FIG. 1.

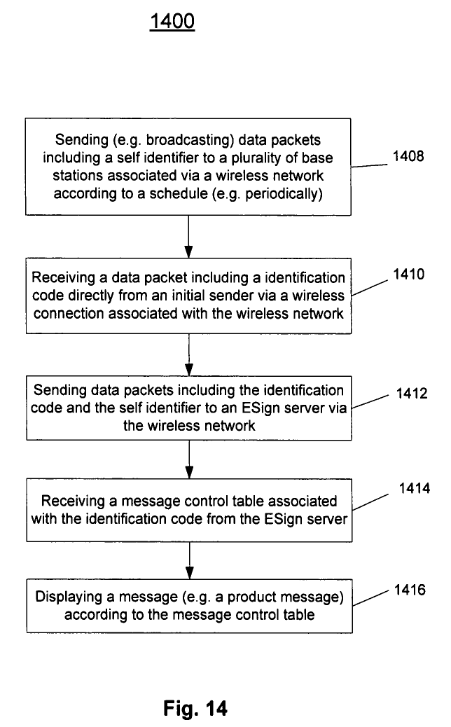

FIG. 14 is a flow diagram illustrating one embodiment of a process to display a location related message according to a machine-readable code wirelessly received. Processing logic may be performed by processing logic (e.g. software or hardware) implemented as part of ESign device 112 of FIG. 7. In one embodiment, processing logic may broadcast data packets over a wireless network, such as ESign network 130 of FIG. 1, to a plurality of associated base stations, such as base station 106, base station 108 and base station 110 of FIG. 1. At block 1408, processing logic may send data packets to a plurality of base stations according to a schedule stored in a storage such as storage 706 of FIG. 7. In one embodiment, processing logic may broadcast data packets periodically at predetermined intervals. At block 1410, processing logic may receive a wireless data packet including an identification code (e.g. product code) directly from an initial sender, such as portable device 104 of FIG. 1, over a wireless network associated with the sender, such as ESign network 130 of FIG. 1. The wireless data packet may be directly received over a wireless medium. In one embodiment, at block 1414, processing logic may send data packets including the received identification code and an identifier identifying, for example, ESign device 112 of FIG. 1, to an ESign server, such as ESign server 101 of FIG. 1, via a wireless network, such as ESign network 130 of FIG. 1. In response, at block 1416, processing logic may receive a message control table, such as message control table 814 of FIG. 8, associated with the identification code from the ESign server. In one embodiment, processing logic may store the received identification code at block 1410 in a local storage, such as storage 706 of FIG. 7, before sending out the identification code at block 1412. At block 1418, processing logic may display a product message associated with the identification code according to the received message control table.

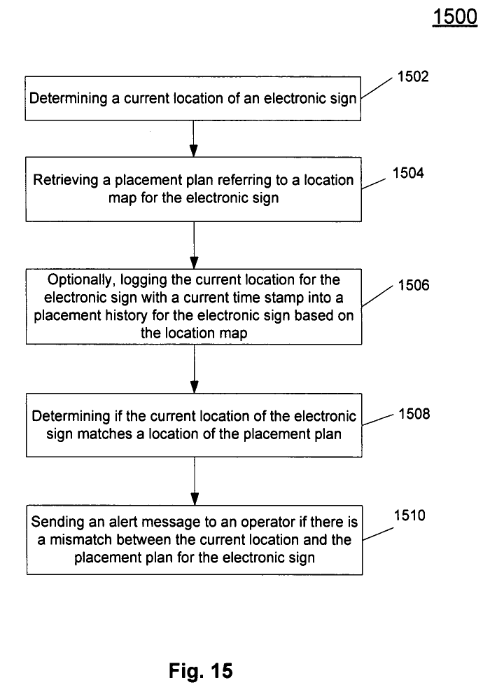

FIG. 15 is a flow diagram illustrating one embodiment of a process to monitor locations of an electronic sign according to a placement plan. Processing logic may be performed by processing logic (e.g. software or hardware) implemented as part of system 400 of FIG. 4. At block 1502, processing logic may determine a current location of an electronic sign, such as ESign 112 of FIG. 1. Process 1502 may locate an electronic sign similar to process 1000 at block 1010 of FIG. 10. An electronic sign may be identified by an identifier received from a data packets sent by the electronic sign. In another embodiment, an electronic sign identifier may be retrieved from a data storage, such as ESign information table 426 in data storage 402 of FIG. 4. At block 1504, processing logic may retrieve a placement plan referring to a location map, such as location map 420 of FIG. 4, for the electronic sign. A placement plan may be associated with an electronic sign identifier in an information table, such as ESign information table 426 of FIG. 4. In one embodiment, a placement plan may include a schedule of locations to determine, for example, when and at what location an electronic sign should be placed within a location map.

At block 1506, processing logic may optionally log the current location of the electronic sign with a current time stamp into a placement history for the electronic sign. The current location may be logged referring to, for example, geometric positions according to the location map. At block 1508, processing logic may determine if the current location of the electronic sign matches the retrieved placement plan with respect to the current time. In one embodiment, a current location may match a placement plan if the current location falls within a current zone, such as zone Z2 530 of FIG. 5B, included in the placement plan based on the current time. In another embodiment, whether a current location match a placement plan may be based on a predetermined maximum distance between the current location and a planned location at the current time within the placement plan. If a mismatch is identified at block 1510, processing logic may send an alert message to an operator. In one embodiment, processing logic may send an alert message to a client system, such as operator client 132 of FIG. 1, if the current location of an electronic sign is determined not to match the corresponding placement plan.

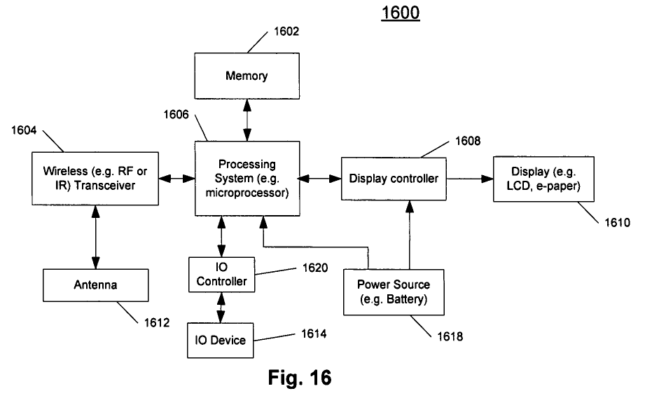

FIG. 16 illustrates one example of a data processing system which may be used in an embodiment of an electronic sign of the present invention. For example, system 1600 may be implemented as part of system as shown in FIG. 7. The data processing system 1600 shown in FIG. 16 includes a processing system 1606, which may be one or more microprocessors, or which may be a system on a chip integrated circuit, and the system also includes memory 1602 for storing data and programs for execution by the processing system. A display 1610, such as an LCD or an EPD, may be coupled to the processing system 1606 via a display controller 1608. A user may initiate certain functions of the system 1600 via an 10 device 1614, such as a simple button, coupled with an 10 controller 1620.

The system 1600 also includes one or more wireless transceivers 1604 to communicate with another data processing system, such as the system 600 of FIG. 6 or system 900 of FIG. 9. A wireless transceiver may be a RF transceiver for an active RFID network. An antenna system 1612 may be coupled with the wireless transceiver 1604. Additionally, system 1600 may optionally include a power source 1618. The power source may be a built-in battery or a replaceable battery. In one embodiment, power source 1618 may be based on solar energy source or driven by an external energy source. It will be appreciated that additional components, not shown, may also be part of the system 1600 in certain embodiments, and in certain embodiments fewer components than shown in FIG. 16 may also be used in a data processing system.

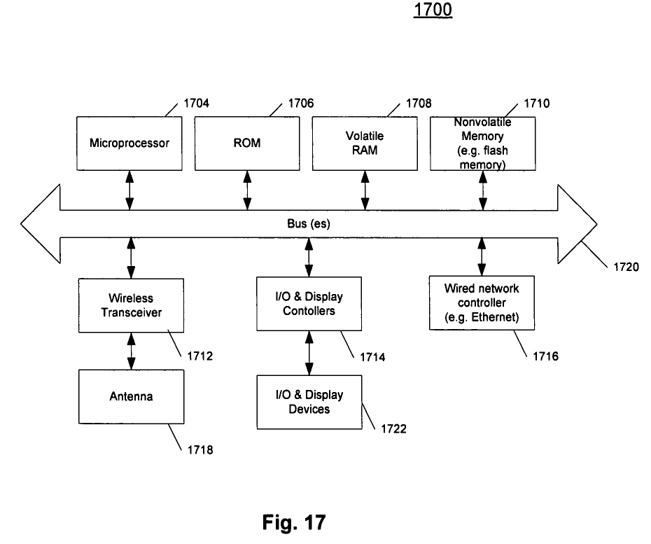

FIG. 17 illustrates one example of a data processing system which may be used in an embodiment of a base station of the present invention. For example, the system 1700 may be implemented as a part of the systems shown in FIG. 6. Note that while FIG. 17 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 17, the data processing system, includes a bus 1720 that is coupled to a microprocessor(s) 1704, a ROM (Read Only Memory) 1706, volatile RAM 1708, and a non-volatile memory 1710. The microprocessor 1704 may retrieve the instructions from the memories 1706, 1708, 1710 and execute the instructions to perform operations described above. The bus 1720 interconnects these various components together and also interconnects these components 1704, 1706, 1708, and 1710 to I/O (input/output) and display controllers 1714 coupled with I/O and display devices 1722. The volatile RAM (Random Access Memory) 1708 is typically implemented as dynamic RAM (DRAM) which requires power continually in order to refresh or maintain the data in the memory.

Additionally, a wireless transceiver 1712 may be coupled with bus 1720 to provide an interface to a wireless network. The wireless transceiver 1712 may be a radio frequency (RF) transceiver (e.g., an RF transceiver for an RFID wireless network) or a Wi-Fi transceiver for IEEE 802 based wireless network. Transceiver 1712 may be coupled with an antenna system 1718. A wired network controller 1716 may be coupled with bus 1720 to interface with other networks such as an Ethernet.

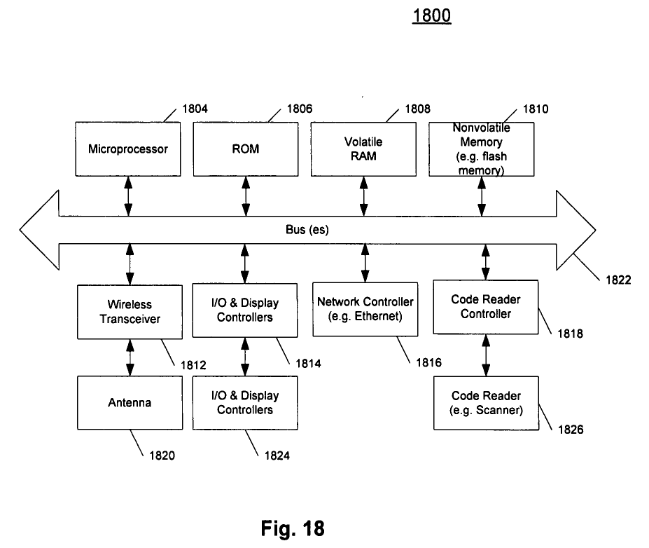

FIG. 18 illustrates one example of a data processing system which may be used in an embodiment of a portable device of the present invention. For example, the system 1800 may be implemented as a part of the systems shown in FIG. 9. Note that while FIG. 18 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 18, the data processing system, includes a bus 1822 that is coupled to a microprocessor(s) 1804, a ROM 1806, volatile RAM 1808, and a non-volatile memory 1810. The microprocessor 1804 may retrieve the instructions from the memories 1806, 1808, 1810 and execute the instructions to perform operations described above. The bus 1822 interconnects these various components together and also interconnects these components 1804, 1806, 1808, and 1810 to I/O and display controllers 1814 coupled with I/O and display devices 1824. The volatile RAM 1808 is typically implemented as DRAM.

Additionally, a wireless transceiver 1812 may be coupled with bus 1822 to provide an interface to a wireless network. The wireless transceiver 1812 may be a radio frequency (RF) transceiver or a Wi-Fi transceiver. Transceiver 1816 may be coupled with an antenna system 1820. A wired network controller 1818 may be coupled with bus 1822 to interface with other networks such as an Ethernet. A code reader controller 1818 may be coupled with buses 1822 to interface with a code reader device 1826, such as an optical scanner or a bar code reader.

FIG. 1900 illustrates one example of a typical computer system which may be used in an ESign server in one embodiment of the present invention. For example, the system 1900 may be implemented as a part of the system shown in FIG. 4. Note that while FIG. 1900 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

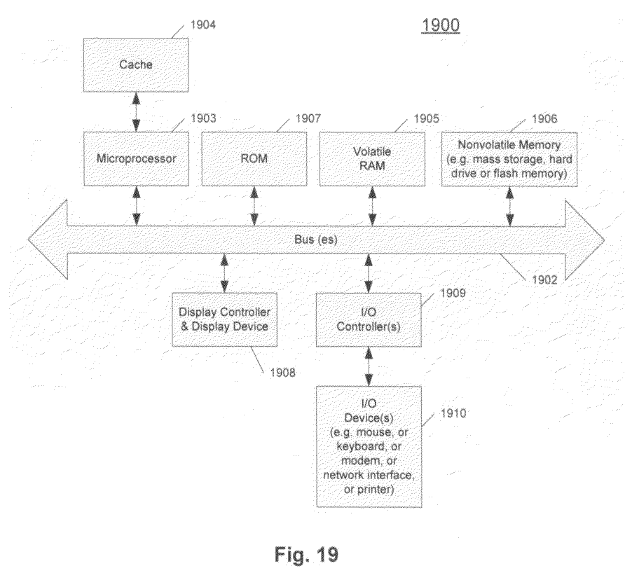

As shown in FIG. 19, the computer system 1900, which is a form of a data processing system, includes a bus 1902 which is coupled to a microprocessor(s) 1903 and a ROM 1907, a volatile RAM 1905 and a non-volatile memory 1906. The microprocessor 1903 may retrieve the instructions from the memories 1907, 1905, 1906 and execute the instructions to perform operations described above. The bus 1902 interconnects these various components together and also interconnects these components 1903, 1907, 1905, and 1906 to a display controller and display device 1908 and to peripheral devices such as I/O devices which may be mice, keyboards, modems, network interfaces, printers and other devices which are well known in the art. Typically, the I/O devices 1910 are coupled to the system through I/O controllers 1909. The volatile RAM 1907 is typically implemented as dynamic RAM (DRAM).

The mass storage 1906 is typically a magnetic hard drive or a magnetic optical drive or an optical drive or a DVD RAM or a flash memory or other types of memory systems which maintain data (e.g. large amounts of data) even after power is removed from the system. Typically, the mass storage 1906 will also be a random access memory although this is not required. While FIG. 19 shows that the mass storage 1906 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 1902 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A machine implemented method, comprising:
in response to a signal wirelessly received from an electronic sign associated with one or more object items, determining whether the electronic sign is placed within a proximity of the one or more object items based on the signal and a location of the one or more object items; and
wirelessly transmitting presentation information to the electronic sign if it is determined that the electronic sign is located within the proximity of the one or more object items, wherein the presentation information is presented at the electronic sign describing the one or more object items.

2. The method of claim 1, further comprising wirelessly transmitting a special message to the electronic sign to be displayed at the electronic sign indicating that the electronic sign is not associated with the one or more object items, if it is determined that the electronic sign is not placed within the proximity of the one or more object items.

3. The method of claim 2, further comprising transmitting an alert message to a remote facility over a network indicating that the electronic sign is not within the proximity of the one or more object items to enable an operator associated with the one or more object items to perform one or more operations with respect to at least one of the electronic sign and the one or more object items.

4. The method of claim 1, further comprising:
wirelessly receiving an identifier of the one or more object items which is obtained by scanning a machine-readable code attached to the one or more object items; and
wirelessly receiving an identifier of the electronic sign which is wirelessly transmitted from the electronic sign.

5. The method of claim 4, further comprising associating the electronic sign with the one or more object items based on the identifiers of the electronic sign and the one or more object items.

6. The method of claim 5, further comprising:
scanning via a portable device the machine-readable code of the one or more object items to obtain the identifier of the one or more object items; and
wirelessly receiving the identifier of the one or more object items from the portable device.

7. The method of claim 6, further comprising determining a location of the one or more object items based on a signal wirelessly received from the portable device while the portable device is scanning the machine-readable code of the one or more object items, wherein the proximity of the one or more object items is determined based on the location of the portable device.

8. The method of claim 6, further comprising wirelessly transmitting from the portable device the identifier of the one or more object items to the electronic sign to allow the electronic sign to represent the associated one or more object items.

9. The method of claim 6, further comprising:
scanning using the portable device a second machine-readable code from a printed section of the electronic sign, the second machine-readable code identifying the one or more object items associated with the electronic sign; and
the portable device transmitting the second machine-readable code to an electronic section of the electronic sign to enable the electronic sign to display an electronic message associated with the second machine-readable code.

10. The method of claim 9, further comprising wirelessly receiving the second machine-readable code from the electronic section of the electronic sign, wherein the electronic sign is associated with the one or more object items represented by the second machine-readable code.

11. The method of claim 5, further comprising:
determining a location of the electronic sign based on a received signal strength (RSS) of the signal wirelessly transmitted from the electronic sign periodically; and
dynamically verifying whether the electronic sign is currently located within the proximity of the one or more object items based on the RSS of the signal.

12. The method of claim 11, wherein the electronic sign is one of a plurality of electronic signs, each associated with a group of one or more object items, wherein the method further comprises generating an electronic map representing a geographic layout of the electronic signs and their associated object items.

13. The method of claim 12, wherein the electronic map includes information indicating whether a particular electronic sign is currently located within a proximity of a particular object item.

14. The method of claim 12, further comprising in response to a request from a user, presenting the electronic map to the user over a network to enable the user to view a current layout configuration of the electronic signs.

15. The method of claim 14, further comprising:
receiving an input from the user selecting one of the electronic signs presented on the electronic map; and
in response to the input, transmitting to the user over a network information associated with electronic sign and one or more object items associated with the selected electronic sign.

16. The method of claim 15, wherein the information associated with the selected electronic sign includes at least one of an identifier of the electronic sign, an identifier of the one or more object items associated with the selected electronic sign, and information regarding the one or more object items and presented by the selected electronic sign.

17. The method of claim 15, further comprising:
receiving a registration from the user for a notification of any updates on the information associated with the electronic sign;
in response to any changes of the information of the electronic sign, including whether the electronic sign is within or outside of the proximity of the associated one or more object items, notifying the user over the network about the changes of the information associated with the electronic sign.

18. A machine-readable medium having instructions stored therein, which when executed, cause a machine to perform a method, the method comprising:
in response to a signal wirelessly received from an electronic sign associated with one or more object items, determining whether the electronic sign is placed within a proximity of the one or more object items based on the signal and a location of the one or more object items; and
wirelessly transmitting presentation information to the electronic sign if it is determined that the electronic sign is located within the proximity of the one or more object items, wherein the presentation information is presented at the electronic sign describing the one or more object items.

19. A data processing system, comprising:
a wireless transceiver to receive a signal received from an electronic sign associated with one or more object items;
a processing logic coupled the wireless transceiver to determine whether the electronic sign is placed within a proximity of the one or more object items based on the signal and a location of the one or more object items,
wherein the wireless transceiver to transmit presentation information to the electronic sign if it is determined that the electronic sign is located within the proximity of the one or more object items, wherein the presentation information is presented at the electronic sign describing the one or more object items.

20. A machine implemented method performed by an electronic sign, comprising:
periodically transmitting a signal to a remote server over a wireless network to allow the remote server to determine a location of the electronic sign;
wirelessly receiving presentation information from the remote server in response to the signal indicating that the electronic sign is located within a proximity of one or more object items; and
displaying the presentation information at a display of the electronic sign, the presentation information describing the one or more object items.

21. The method of claim 20, further comprising:
wirelessly receiving an error message from the remote server if the remote server determines that the electronic sign is outside the proximity of the one or more object items; and
displaying the error message at the display indicating that the electronic sign is not currently associated with the one or more object items.

22. The method of claim 20, wherein the electronic sign includes a printed section and an electronic section having the display, and wherein the method further comprises:
wirelessly receiving an identifier identifying one or more object items, the identifier being scanned from a machine-readable code physically printed on the printed section of the electronic sign;
wirelessly transmitting the identifier of the one or more object items and an identifier of the electronic sign to the remote server to allow the remote server to associate the electronic sign with the one or more object items.

23. The method of claim 22, further comprising:
receiving the presentation information from the remote server in response to the association of the electronic sign and the one or more object items; and
displaying the presentation information in the display of the electronic sign.

24. A machine implemented method performed by a portable device, comprising:
scanning a machine-readable code printed on a surface of an object item, the machine-readable code identifying the object item; and
wirelessly transmitting a signal representing the machine-readable code to a remote server, the signal further indicating a location of the object item to enable the remote server to associate the object item with an electronic sign based on the location of the object item.

25. The method of claim 24, further comprising wirelessly transmitting the machine-readable code to the electronic sign associated with the object item to allow the electronic sign to wirelessly transmit the machine-readable code and an identifier of the electronic sign to the remote server for the association.

26. A system, comprising:
a server;
a plurality of electronic signs communicatively coupled to the server, wherein each electronic sign is associated with one or more object items, each electronic sign displaying presentation information describing the associated one or more object items,
wherein each electronic sign wirelessly periodically transmits a signal to the server to allow the server to determine a location of an electronic sign and to determine whether the electronic sign is located within a proximity of one or more object items associated with the electronic sign based on the location of the electronic sign and a location of the one or more object items,
wherein if the server determines that the electronic sign is located within the proximity of the one or more object items, the server transmits the presentation information to the electronic sign to be displayed, and
wherein if the server determines that the electronic sign is outside of the proximity of the one or more object items, the server transmits an error message to the electronic sign to indicate that the electronic sign is not associated with the one or more object items.

27. The system of claim 26, further comprising a plurality of base_stations coupling the server and the plurality of electronic signs, wherein each base_station is associated with one or more electronic signs, and wherein each electronic sign communicates with the server via the associated base_station.

28. The system of claim 27 further comprising a portable device configured to scan a first machine-readable code attached to the one or more object items and to wirelessly transmit the machine-readable code to the server, wherein the first machine-readable code identifies the one or more object items, and wherein the portable device further transmits a signal to the server to allow the server to determine a location of the one or more object items.

29. The system of claim 28, wherein the portable device further scans a second machine-readable code from a printed section of an electronic sign and transmits the second machine-readable code into an electronic section of the electronic sign, wherein the second machine-readable code identifying an object item that is represented by information displayed by the electronic section of the electronic sign.

30. The system of claim 29, wherein the electronic sign transmits the second machine-readable code and its identifier to the server to enable the server to associate the electronic sign with the object item identified by the second machine-readable code, and wherein in response to the association, the server transmits presentation information to the electronic sign to be displayed, the presentation information describing the associated object item.
